(19) United States
(12) Patent Application Publication
(10) Pub. No.: US 2006/0192763 A1
(43) Pub. Date: Aug. 31, 2006

(54) Sound-based virtual keyboard, device and method

(76) Inventor: Theodore B. Ziemkowski, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/066,748

(22) Filed: Feb. 25, 2005

(51) Int. Cl. G09G 5/00

(52) U.S. Cl. 345/168

(57) ABSTRACT

A virtual input apparatus uses an array of transducers in contact with a sounding surface to detect a location of a sound or vibration transmitted by the sounding surface. A signal processor connected to an output of the transducer array provides data corresponding to a determined location of the vibration detected by the array. An electronic device includes a virtual keyboard that includes the array of transducers and device electronics. A method of entering data for the electronic device using the virtual keyboard includes creating a sound with a sounding surface that represents data to be entered into the electronic device by a user. The method further includes determining a point of origin of the created sound and mapping the determined point of origin into the data.

### BACKGROUND

1. Technical Field

The invention relates to electronic devices and systems. In particular, the invention relates to data entry and control input for electronic devices and systems.

2. Description of Related Art

Modern consumer electronic devices, especially so-called ‘personal electronic devices’ (PEDs), are often typified by the portability of the device. In turn, device portability has driven and continues to drive a general trend toward smaller and smaller sizes of such devices. Unfortunately, small device size necessarily limits available real estate on the device itself for implementing a user interface integrated with the device. In short, there is only so much room for buttons, keys, keypads, touch pads, and thumbwheels on the typically small housings of PEDs and related modern consumer electronic devices.

Concomitant with the trend toward smaller device size is a trend toward ever-increasing operational sophistication and overall device capability of PEDs. The resulting feature-rich performance characteristics of such modern devices, while generally satisfying the market demand, necessarily impacts the quantity and complexity of the user interactions required by the device. More features generally mean more choices for or inputs from the user. In turn, each choice must be implemented by the user interface. As such, user interactions, primarily in the form of data entry and/or control input through the integrated user interface, are often problematic for PEDs and related modern consumer electronic devices.

Alternatives to the integrated user interface for addressing complex user interactions with PEDs include using peripheral input appliances such as, but not limited to, a conventional keyboard and/or computer mouse. Unfortunately, such peripheral input appliances, while widely used and generally accepted in many applications, are often not well suited to PEDs. In particular, peripheral input appliances may have a significant negative impact on device portability. For example, carrying a keyboard to interface with a personal digital assistant (PDA) may be inconvenient in some instances and entirely impractical in others. As such, using peripheral input appliances is simply not a viable alternative in many situations.

Accordingly, it would be advantageous to have a way of interfacing with an electronic device or system to provide data entry and/or control input that did not require using a peripheral input appliance or a complex integrated user interface of the device. Such a data input apparatus and method would solve a long-standing problem in the area of interfacing with portable electronic devices and/or systems.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a block diagram of a virtual keyboard apparatus according to an embodiment of the present invention.

FIG. 2A illustrates a perspective view of a virtual keyboard apparatus depicting an exemplary keyboard template according to an embodiment of the present invention.

FIG. 2B illustrates a perspective view of a virtual keyboard apparatus depicting another exemplary keyboard template according to an embodiment of the present invention.

FIG. 3 illustrates a side view an electronic device employing a virtual keyboard apparatus according to an embodiment of the present invention.

FIG. 4 illustrates a block diagram of an electronic device with a virtual keyboard according to the present invention.

FIG. 5A illustrates a perspective view of the electronic device of FIG. 4 in the form of an exemplary digital camera according to an embodiment of the present invention.

FIG. 5B illustrates a side view of the exemplary digital camera illustrated in FIG. 5A.

FIG. 6 illustrates a perspective view of the electronic device of FIG. 4 in the form of an exemplary docking station for interfacing to a PED according to an embodiment of the present invention.

FIG. 7 illustrates a flow chart of a method of data entry for a portable electronic device using a virtual keyboard according to an embodiment of the present invention.

### DETAILED DESCRIPTION

Embodiments of the present invention facilitate data entry and/or control input to an electronic device. In particular, the embodiments essentially provide a ‘virtual keyboard’ for interacting with the electronic device. Through the virtual keyboard, a user of the electronic device is able to interact with the device as is done with a typical keyboard, keypad, or other similar peripheral input appliance. However, unlike the typical input appliance, the virtual keyboard does not adversely affect portability of the electronic device according to the embodiments of the present invention.

In some embodiments of the present invention, a virtual input apparatus is provided. The virtual input apparatus essentially determines a location of an input by detecting and locating an acoustical event (e.g., sound or vibration) associated with the input. For the various embodiments of the present invention, the terms ‘acoustic(al)’, ‘sound’ and ‘vibration’ have the same meaning and are used interchangeably, unless otherwise defined herein. For example, the virtual input apparatus may be a virtual keyboard that employs as an input a sound associated with finger ‘tapping’ on a ‘sounding surface’ such as, but not limited to, a table top or surface. The virtual keyboard may be used to enter data or ‘key strokes’ into an electronic device, for example. Continuing with the example, to enter a key stroke, a user taps on the sounding surface at a pre-determined location associated with a desired key on the virtual keyboard. The virtual keyboard detects the tap as an acoustical input event and determines a location corresponding to the event.

After determining the event location, the virtual keyboard associates the event location with a specific entry or input (e.g., a key of the keyboard) and transmits the input to the electronic device. As such, according to some embodiments of the present invention, operation of the virtual keyboard is analogous to data entry using a conventional keyboard or related input device (e.g., mouse). However, unlike the conventional keyboard, no actual physical keyboard or similarly cumbersome input appliance is required for these embodiments of the present invention. The virtual keyboard embodiments according to the present invention provide data entry and/or control input to the electronic device without the presence of an actual or physical input appliance that may adversely affect portability or other characteristics of the electronic device.

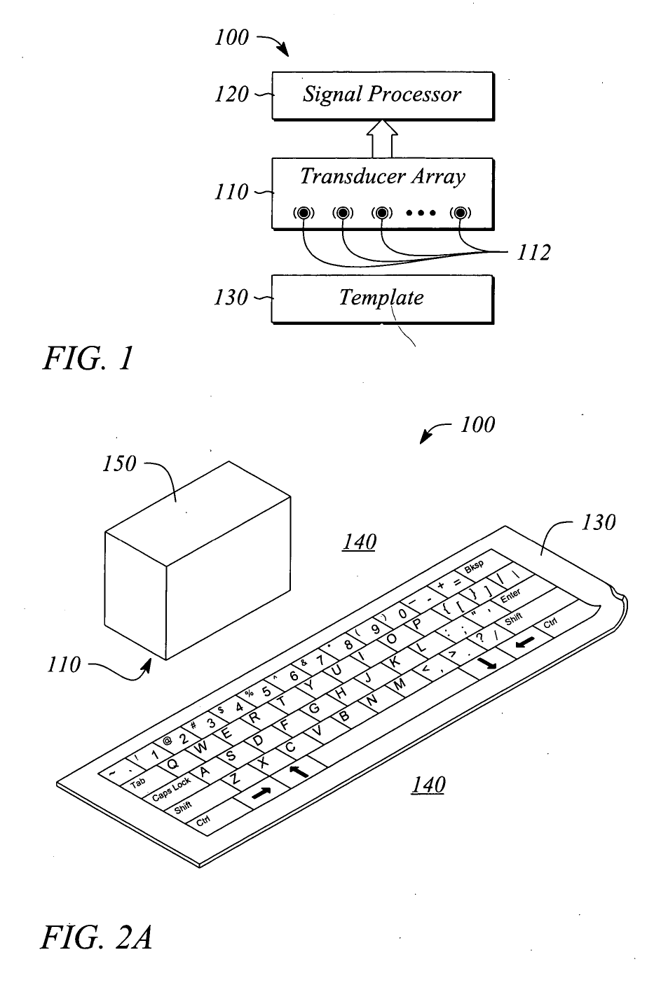

FIG. 1 illustrates a block diagram of a virtual keyboard apparatus 100 according to an embodiment of the present invention. The virtual keyboard apparatus 100 comprises an array 110 of acoustic or vibration transducers 112. In some embodiments, the array 110 comprises two or more vibration transducers 112. For example, the array 110 may comprise three vibration transducers 112. Each vibration transducer 112 in the array 110 is spaced apart from other transducers 112 of the array 110. For example, three transducers 112 may be arranged in the array 110 such that the transducers 112 collectively form a planar triangular array. In particular, for this example, each of the three transducers 112 may be located at a different one of three vertices of a triangle including, but not limited to, an isosceles triangle and an equilateral triangle. Moreover, a relative location of the three transducers 112 defines a planar surface.

In another example, four vibration transducers 112 may be arranged in a rectangular array 110 with one transducer at each of four vertices of a rectangle. In another example, two or more vibration transducers 112 may be arranged in a linear array 110. In yet another example, five transducers 112 may be arranged to form a pentagonal array 110. One skilled in the art can readily devise any number of two-dimensional and three-dimensional configurations of spaced-apart transducers 112 that form an array 110. All such configurations are within the scope of the embodiments of the present invention.

The transducer 112 may be essentially any means for detecting or sensing vibration corresponding to an input. For example, the transducer 112 may be a microphone such as, but not limited to, a condenser microphone, a dynamic microphone, a crystal or piezoelectric microphone, and a ribbon microphone. In another example, the transducer 112 may be an accelerometer or related motion detector. In yet another example, the vibration transducer 112 may be an indirect or non-contact detector such as, but not limited to, a laser-based deflection sensor used for remote detection of vibration of a material surface (e.g., plate glass window). A laser deflection sensor measures vibration in a surface by illuminating the surface with a laser beam and detecting vibrations in the surface as a deflection of the laser beam.

In general, the detected vibration or sound may include, but is not limited to, a longitudinal acoustical wave and/or a transverse acoustical wave traveling in air or another material and/or traveling along a surface of the material. For example, the vibration may be sound generated by tapping a planar surface of a table top (i.e., sounding surface) wherein the sound travels one or both of through the air surrounding the planar surface and through the material of the table. The transducer 112 detects and transforms vibrations into another energy form such as an electrical impulse or signal. One skilled in the art is familiar with vibration or sound transducers.

The virtual keyboard apparatus 100 further comprises a signal processor 120. The signal processor 120 collects and processes signals output or generated by the individual transducers 112. For example, the signal processor 120 may receive electrical signals from the transducers 112. In some embodiments, the received signals are one or both of amplified and filtered by the signal processor 120. In particular, the received signals may be amplified by the signal processor 120 to improve a signal level for processing and may be filtered to remove or reduce effects of noise and/or other interfering signals. In some embodiments, the signal processor 120 is a digital signal processor that digitally processes the received signals. In particular, the digital signal processor 120 may sample and digitize the signals from the individual transducers 112 and then apply digital processing to the digitized signal. Digital signal processing may include, but is not limited to, digital filtering, digital signal recognition and event timing, and digital signal source determination.

The signal processor 120 determines a location or source of the vibration/sound event detected by the transducer array 110. In particular, any one of various triangulation methodologies and techniques may be employed by the signal processor 120 to determine the event location. For example, time-of-arrival algorithms, such as those familiar to one skilled in the art, may be employed by the signal processor 120 to determine the event location. In particular, a time-of-arrival algorithm determines an event location using a determination of differential arrival time of the vibration event at each of the transducers 112. From the differential arrival time, a most probable location for the source of the vibration event may be determined. For example, information regarding the speed of propagation of the vibration from the event source to the transducers 112 and well-known geometric principles enable such determination.

In some embodiments, an output of the signal processor 120 is simply a location of a vibration event source or a point or origin of the sound. In other embodiments, the signal processor 120 further maps the determined location into a ‘key’ configuration. The key configuration is a predetermined relationship between possible event sources and keys of a virtual keyboard of the keyboard apparatus 100. The key configuration may be stored in memory available to the signal processor 120, for example. Thus, when a location is determined, the location may be compared by the signal processor 120 to the stored key configuration. From the comparison, a specific key is selected, thereby completing the mapping of the event location into the key configuration. In such embodiments, the output of the signal processor 120 is an identity of a key corresponding to the vibration source location.

For example, the signal processor 120 may compare a determined location of the vibration source with a pre-defined set of coordinates that define locations of keys as boxes or rectangles arranged as if the boxes were keys of a ‘QWERTY’ keyboard. A determined event location that falls inside one of the pre-defined boxes maps to a key corresponding to the box in the key configuration. In another example, the detected event may correspond to a finger being dragged or slid across a table or sounding surface. In other words, the event is a sound source that is moving with time. As such, the mapped key configuration corresponds to a moving location that follows or tracks the finger on the table. Such a mapping resembles the action of a computer mouse. One skilled in the art is familiar with a wide variety of such mappings, all of which are within the scope of the present invention.

In some embodiments, the signal processor 120 comprises a circuit identifiable as a specialized or dedicated signal processor. In particular, the functionality of the signal processor 120 is essentially determined by circuitry or a circuit configuration of the dedicated signal processor. Such a dedicated signal processor may be implemented as a signal processing integrated circuit (IC) or as a portion of an application specific integrated circuit (ASIC) and/or a field programmable gate array (FPGA) that provide signal processing functionality. In such embodiments, the signal processor circuit may include an analog-to-digital converter (ADC) as part of the circuit.

In other embodiments, the signal processor 120 comprises a computer program or portion thereof that is executed by a programmable processor such as, but not limited to, a general purpose computer or microprocessor/microcontroller, and a programmable signal processor. In these embodiments, functionality of the signal processor 120 is determined by or embodied in instructions of the computer program. In such embodiments, the ADC may be provided as part of the programmable processor or may be a separate circuit from that of the programmable processor.

In yet other embodiments, the signal processor 120 may be implemented as discrete circuits dedicated to the determination of the sound origin point and key mapping functionality of the signal processor 120. In yet other embodiments, the signal processor 120 may comprise one or more of a physical signal processor, a computer program, and discrete circuits.

Regardless of the embodiment, the signal processor 120 may carry out other functions in addition to that associated with the virtual keyboard apparatus 100. For example, the signal processor 120 may be a processor of an electronic device equipped with the virtual keyboard apparatus 100, wherein the processor acts as the signal processor 120 only while receiving and processing an input to the virtual keyboard apparatus 100.

In some embodiments, the virtual keyboard apparatus 100 further comprises a keyboard template 130. The keyboard template 130 provides a user with a guide or map to locations of virtual keys. In particular, the keyboard template 130 assists the user in making inputs to the device by way of the virtual keyboard apparatus 100 by indicating or identifying a ‘physical’ location that corresponds to a virtual key location associated with the predetermined mapping of the signal processor 120. In other words, the template 130 is a physical, visual representation of the key mapping of the virtual keyboard apparatus 100. As such, the keyboard template 130 assists the user with use of the virtual keyboard apparatus 100. In some embodiments, the virtual keyboard apparatus 100 may be used with or without the keyboard template 130 at the discretion of the user. For example, the user may choose to employ the keyboard template only while learning the keyboard layout. Therefore, the inclusion of the keyboard template 130 in FIG. 1 is illustrative only of some embodiments.

In one example, the keyboard template 130 is a planar element that is placed on a sounding surface 140 (e.g., table top). For example, the keyboard template 130 is a sheet or film of material marked or imprinted with key locations that map or mimic a keyboard. The template 130 sheet may be relatively flexible and comprise a material such as, but not limited to, paper, cardboard, Mylar®, vinyl, cloth or another material. The keyboard template is manipulatable for compact storage when not in use.

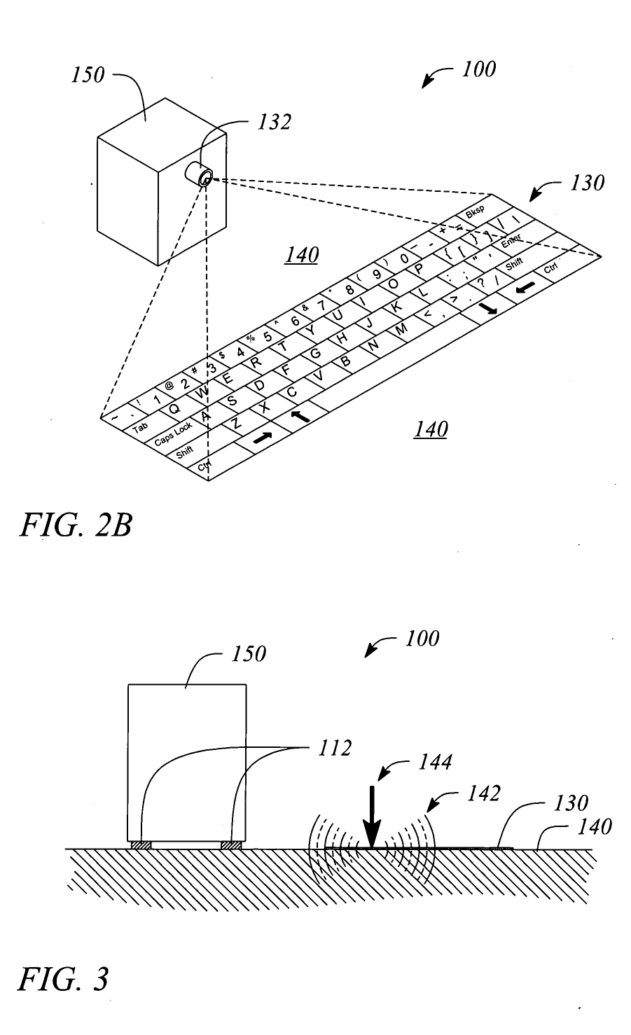

FIG. 2A illustrates an exemplary keyboard template 130 as an imprinted sheet according to an embodiment of the present invention. Also illustrated in FIG. 2A is means 150 for employing the virtual keyboard apparatus 100. The means 150 for employing the apparatus 100 generally is a housing that incorporates one or both of the transducer array 110 and the signal processor 120, by way of example. In some embodiments, the means 150 for employing the apparatus 100 is an electronic device 150.

The template 130 sheet is placed on the sounding surface 140 prior to use of the virtual keyboard apparatus 100. The template 130 acts as a guide for the user to locate specific keys of the keyboard map depicted on the template 130. The keyboard map corresponds to specific key locations of the virtual keyboard apparatus 100. As such, the template 130 facilitates the user's use of the virtual keyboard apparatus 100.

In another example, the keyboard template 130 is an optically projected or presented template. FIG. 2B illustrates an exemplary keyboard template as an optically projected pattern according to an embodiment of the present invention. For example, the virtual keyboard apparatus 100 may provide a projector 132 that creates and optically projects the keyboard template 130 onto the sounding surface 140. The projector 132 may be housed in the means 150 for employing the apparatus 100 in some embodiments, such as the embodiment illustrated in FIG. 2B. In such embodiments, the template 130 is registered essentially automatically by where on the sounding surface the template 130 is projected. Examples of projected templates 130 are further described by Rafii et al., U.S. Pat. No. 6,614,422 B1, and by Amon, U.S. Pat. No. 6,650,318 B1, both of which are incorporated herein by reference.

In some embodiments, a registration of the template 130 is predetermined. The template ‘registration’ is a location and/or orientation of the template 130 relative to the virtual keyboard apparatus 100 (i.e., the means 150 for employing). In one such embodiment, the user simply places the template 130 in a predetermined location and orientation determined by a location of the means 150 for employing prior to using the virtual keyboard apparatus 100. For example, the predetermined location, known a priori by the user, may be a position one inch in front of the means 150 for employing centered on and perpendicular to a centerline of the means 150. In other words, the user ‘registers’ the template 130 with the apparatus 100 by properly placing and orientating the template 130 relative to the means 150 for employing.

In other embodiments, registration of the template 130 is determined interactively between the user and the apparatus 100. In particular, during template registration, the user enters registration points corresponding to a location, orientation, and optionally a size or scale of the template 130. The virtual keyboard apparatus 100 employs the entered registration points to adjust the keyboard map to correspond to the entered registration points. As such, the registration of the template 130 is based on the user-entered registration points instead of being based on a predetermined template registration.

For example, to register the template 130, the user may tap the sounding surface 140 at two or more locations to indicate registration points for the keyboard template 130 (e.g., tap the four corners of the sheet template 130). The locations of the taps are determined by the virtual keyboard apparatus 100. The determined locations are then used to define various template parameters including the location, orientation, and size of the template. From the defined template parameters, the mapping used by the virtual keyboard apparatus 100 is adjusted accordingly.

The interactive registration may apply to either the exemplary sheet or optically projected forms of the template 130. In the case of the sheet form, interactive registration simplifies locating the template 130. In particular, essentially any location and orientation of the planar template 130 may be accommodated by the interactive registration. For example, the sheet template 130 may be positioned on a table as desired by the user. The corners are then tapped and the virtual keyboard apparatus 130 recognizes and adapts to the sheet template 130 positioning through interactive registrations. With the optically projected template 130, a location of the projected template and even a size thereof may be adjusted based on the interactive registration, for example. A user taps on the table or surface 140 at several points to indicate where the projected template is to be positioned. Once the points have been indicated by the user, the projected image is scaled and located on the sounding surface 140 accordingly. Interactive registration further enables a user-defined template to be employed. In particular, by indicating locations of registration points corresponding to particular data to be entered, the virtual keyboard 100 enables a user to define a custom template in some embodiments.

In yet other embodiments, elements or features of the template 130 may facilitate automatic or essentially non-interactive template registration. For example, the template may comprise location tags that are detected by the virtual keyboard apparatus 100. Radio frequency (RF) tags, either passive or active, may be employed to identify to the apparatus 100 a location of the template 130, for example. One or both of optical tags (e.g., optical targets) and optical pattern recognition may be employed by the virtual keyboard 100 to locate and register the template 130. In some of these embodiments, the virtual keyboard apparatus 100 further comprises optical sensors for detecting the optical tags.

In some embodiments of the virtual keyboard apparatus 100, the transducers 112 of the transducer array 110 are in contact with the sounding surface 140. In such embodiments, the sounding surface 140 is a material through which the vibration travels or is transmitted. The transducers 112 pick up or receive the vibration through the contact with the sounding surface 140, as opposed to or in addition to, through the air.

For example, the sounding surface 140 may be a table or desk top and the apparatus 100 may employ the array 110 with three transducers 112. The apparatus 100 is positioned with respect to the table or desk top such that the transducers 112 are resting on and are in contact with the table top or surface. The array 110 with three transducers 112 facilitates having all transducers 112 of the array 110 in firm contact with the table top. A sound generated by tapping on the table top travels through the table to the transducers 112.

In some embodiments, the contact between the array 110 and the table top may be a direct contact. For example, the transducers 112 may be in mechanical or physical contact with the sounding surface 140, as described hereinabove with respect to the table top example. In other embodiments, the contact between the array 110 and the table top is indirect. For example, the transducers 112 may be in mechanical contact with an interface material or structural element that, in turn, is in mechanical or physical contact with the sounding surface 140 (e.g., a rubber pad or sheet between the transducer 112 and the sounding surface 140). In such embodiments, the interface material or structure serves to transmit the vibration from the sounding surface 140 to the transducers 112. In some embodiments, the interface material may comprise an air gap.

FIG. 3 illustrates a side view of an exemplary electronic device 150 employing the virtual keyboard 100 according to an embodiment of the present invention. In particular, FIG. 3 illustrates the electronic device 150 resting on the sounding surface 140 supported by the transducers 112 of the transducer array 110. Thus, the transducers 112 essentially act as ‘feet’ of the electronic device 150. In such embodiments, the transducers 112 may preferentially detect vibration in the sounding surface 140 associated with an input by the user (e.g., tapping on the sounding surface 140) instead of vibrations in a surrounding medium. Tapping on the sounding surface 140 is indicated by a vertical arrow 144 to generate a sound or a vibration 142, which is indicated by curved lines projecting from a location of the tapping 144 in FIG. 3.

For example, the sounding surface 140 may be a table upon which the electronic device 150 is placed during use of the virtual keyboard apparatus 100 and the surrounding medium may be air. Tapping on the table will cause sound waves 142 to travel through the table as well as through the air. Since the transducers 112 (e.g., feet of the electronic device 150) are in physical contact with the table, the sound waves 142 traveling through the table will be more readily detected by the transducers 112 of the array 110 than the sound waves traveling through the air.

In some embodiments, the apparatus 100 may employ an interactive input characterization to better distinguish ‘actual’ acoustical input events using the sounding surface 140 from random and/or extraneous noise from the environment. Such interactive input characterization may be referred to as a ‘learning mode’ in some embodiments. During the interactive input characterization, the apparatus 100 essentially ‘learns’ to recognize actual acoustical input events from background noise. In some embodiments, the interactive input characterization is performed concomitant with template registration.

For example, the apparatus 100 may employ a finger tap characterization in which the apparatus 100 learns to distinguish finger tapping or dragging on the sounding surface 140 from background noise. In some of such embodiments, the apparatus 100 instructs a user to perform one or more sample input events (e.g., finger taps) on the sounding surface 140. The apparatus 100 receives and records the one or more events. The recorded events or transformations thereof may be used to help distinguish actual input events from noise. Transformations of recorded events include, but are not limited to, amplification, filtering, mixing with other signals, and various decompositions known in the art. For example, pattern or template matching between the recorded event and potential ‘actual’ input events may be employed. In other examples, characteristic identifiers of the recorded events may be extracted using one or more signal transformations and the extracted events matched with extracted characteristics of potential actual events. A discrete wavelet transform is an example of one such signal transformation that may be used for extracting identifiers. In other embodiments, adaptive filtering or similar adaptive signal processing may be employed to assist in distinguishing actual inputs from background noise. In yet other examples, techniques such as those employed in speech recognition may be employed.

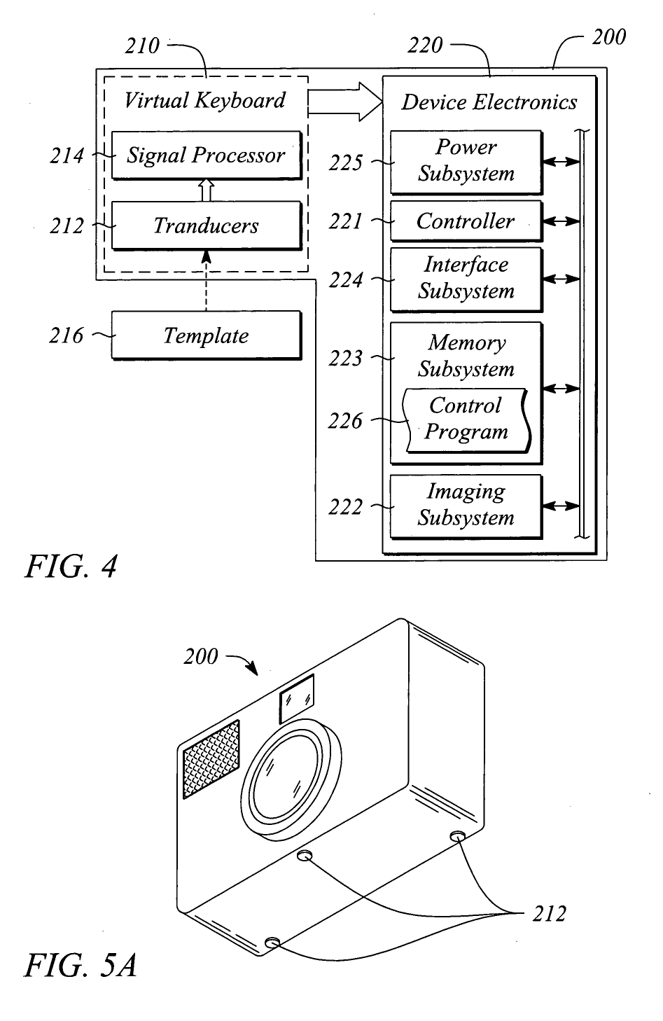

FIG. 4 illustrates a block diagram of an electronic device 200 with an acoustic virtual keyboard according to an embodiment of the present invention. In particular, data is entered or input to the electronic device 200 using a virtual keyboard 210 that acoustically detects and determines an origin of a sound corresponding to the entered data. For example, the sound may be produced by a user tapping or dragging a finger on a table at a specific location or a sequence of locations corresponding to data being entered. The data being entered may correspond to any entry normally associated with the electronic device 200 such as, but not limited to, a key/button entry or a cursor movement. In some embodiments, the electronic device 200 is resting on or supported by a sounding surface and the detected sound is transmitted from the sound point of origin to the device 200 through the sounding surface. In other embodiments, the sound is transmitted through a medium such as air that surrounds the electronic device 200 and the sounding surface.

The electronic device 200 may be essentially any electronic device that employs inputs of data from a user during operation. In particular, the electronic device 200 may be a portable, personal electronic device (PED). The electronic device 200 may include an integral keyboard, keypad or similar input means in addition to the virtual keyboard. For example, the electronic device 200 may be a digital camera, a personal digital assistant (PDA), a remote control for an audio/visual system, a cellular telephone, a video game console, a portable video game unit, an MP3 player, a CD player, or DVD player. In another example, the electronic device 200 is a docking station for any of such PEDs, as mentioned above.

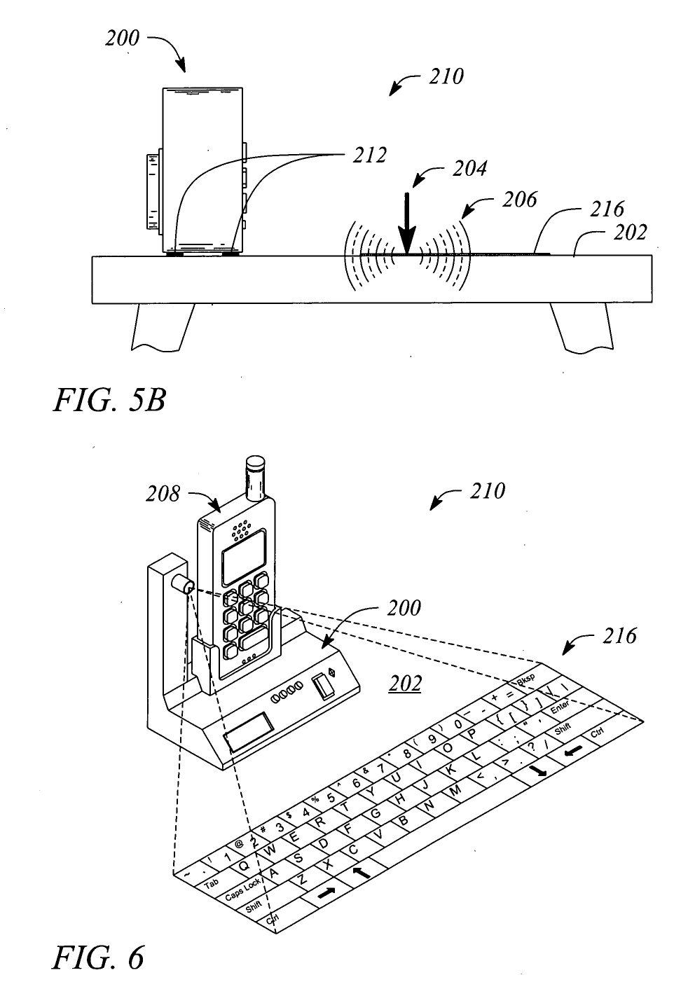

FIG. 5A illustrates a bottom-oriented perspective view of the electronic device 200 of FIG. 4 in the form of an exemplary digital camera 200 according to an embodiment of the present invention. FIG. 5B illustrates a side view of the exemplary digital camera 200 illustrated in FIG. 5A. In particular, FIG. 5B illustrates the exemplary digital camera 200 resting on and supported by a sounding surface 202 depicted as a table. Tapping on the sounding surface 202, as indicated by the arrow 204, produces the sound 206 indicated by curved lines emanating from a location of the tapping 204.

FIG. 6 illustrates a perspective view of the electronic device 200 of FIG. 4 in the form of an exemplary docking station 200 for interfacing to a PED 208 according to an embodiment of the present invention. In FIG. 6, a cellular telephone 208 is illustrated interfaced or docked with the docking station 200 by way of example and not limitation.

Referring back to FIG. 4, the electronic device 200 comprises a virtual keyboard 210. The virtual keyboard 210 acoustically detects and locates the point of origin of the sound 204 (illustrated in FIG. 5B). The virtual keyboard 210 further maps the located point of origin of the sound 204 into a specific data input type. For example, the virtual keyboard 210 may map the point of origin of the sound 204 into a particular one of a plurality of keys defined by the keyboard 210 (e.g., an ‘E’ key of a QWERTY keyboard). In another example, the virtual keyboard 210 may map a point of origin of the sound as a function of time into a movement of a cursor defined by the virtual keyboard 210. Thus, the virtual keyboard 210 allows a user to enter data into the electronic device 200 by producing sounds 204 (e.g., tapping the sounding surface 202 of FIG. 5B) with specific points or origin.

In some embodiments, the virtual keyboard 210 is essentially similar to the virtual keyboard apparatus 100 described hereinabove. In particular, the virtual keyboard 210 comprises an array of transducers 212 that detect the sound 204. The array of acoustic transducers 212 may be essentially the array 110 described hereinabove with respect to the apparatus 100. The virtual keyboard 210 further comprises a signal processor 214 that resolves the point of origin of the sound 204 detected by the transducers 212. In some embodiments, the signal processor 214 may be essentially the signal processor 120 described hereinabove with respect to the apparatus 100. In some embodiments, the virtual keyboard 210 may further comprise a template 216 that assists the user with where to generate the sound such that an intended correspondence between the sound and a specific data entry is maintained. In some embodiments, the template 216 may be essentially the template 130 described hereinabove with respect to the apparatus 100.

Referring again to FIG. 5A, the transducers 212 are illustrated as three disc-shaped supports or feet located on a bottom surface of the exemplary digital camera 200. FIG. 5B illustrates the exemplary digital camera 200 transducer feet 212 in contact with a table top acting as the sounding surface 202. Similarly, the transducers 212 are located in or are respective feet located on a bottom surface (not illustrated) of the docking station 200 illustrated in FIG. 6. An output of the virtual keyboard 210 is transmitted to the docked PED (e.g., cellular telephone 208 in FIG. 6) through a docking interface (not illustrated) of the docking station 200. Also illustrated in FIG. 6 by way of dashed lines is that the keyboard template 216 may be projected onto the sounding surface 202 from the docking station 200 in some embodiments. The projected keyboard template 216 embodiment is similar to the template 130 embodiment projected from the projector 132 of the means 150 for employing the apparatus 100 described above and illustrated in FIG. 2B.

Referring back to FIG. 4, the electronic device 200 further comprises device electronics 220. The device electronics 220 provide the functionality of the device 200. The device electronics 220 receive input key data as an output of the virtual keyboard 210. For example, in some embodiments of the exemplary digital camera 200 illustrated in FIGS. 5A and 5B, the device electronics 220 comprise a controller 221, an imaging subsystem 222, a memory subsystem 223, an interface subsystem 224, a power subsystem 225, and a control program 226 stored in the memory subsystem 223. The controller 221 executes the control program 226 and controls the operation of the various subsystems of device electronics 220 of the digital camera 200. Data entered by a user through the virtual keyboard 210 provides an input to the device electronics 220.

The controller 221 may be any sort of component or group of components capable of providing control and coordination of the subsystems of the device electronics 220. For example, the controller 221 may be a microprocessor or microcontroller. Alternatively, the controller 221 may be implemented as an ASIC or even an assemblage of discrete components. The controller 221 is interfaced to the imaging subsystem 222, the memory subsystem 223, the interface subsystem 224, and the power subsystem 225. In some implementations, a portion of the memory subsystem 223 may be combined with the controller 221. In some embodiments, the virtual keyboard 210 is implemented as a separate subsystem, an output of which is interfaced with the controller 221. In other embodiments, the virtual keyboard 210 is implemented in part as a portion of the control program 226 that is executed by the controller 221 (e.g., the signal processor 214 is a function of the control program 226).

The imaging subsystem 222 comprises optics and an image sensing and recording portion or circuit. The sensing and recording portion may comprise a charge coupled device (CCD) array. During operation of the exemplary camera 200, the optics project an optical image onto an image plane of the image sensing and recording portion of the imaging subsystem 222. The optics may provide either variable or fixed focusing, as well as optical zoom (i.e. variable optical magnification) functionality. The optical image, once focused, is captured and digitized by the image sensing and recording portion of the imaging subsystem 222. Digitizing produces a digital image. The controller 221 controls the image capturing, the focusing and the zooming functions of the imaging subsystem 222. When the controller 221 initiates the action of capturing of an image, the imaging subsystem 222 digitizes and records the image. The digital image is then transferred to and stored in the memory subsystem 223.

The memory subsystem 223 comprises computer memory for storing digital images, as well as for storing the control program 226. In some embodiments, the memory subsystem 223 comprises a combination of read only memory (ROM) and random access memory (RAM). The ROM is used to store the control program 226, while the RAM is used to store digital images from the imaging subsystem 222. The memory subsystem 223 may also store a directory of the images and/or a directory of stored computer programs therein, including the control program 226. In some embodiments, a portion of the virtual keyboard 210 is stored in the memory subsystem 223. For example, a keyboard map used by the virtual keyboard 210 may be stored in the memory subsystem 223.

The interface subsystem 224 comprises buttons used by a user to interact with the control program 226 that is executed by the controller 221, thereby affecting user initiated control of the exemplary digital camera 200. For example, a button may enable the user to initiate an image recording (i.e., ‘snap a picture’). Another button may function as an ON/OFF switch, allowing the camera to be turned ON or OFF. Additionally, the buttons can act as ‘arrow’ keys to allow a value to be incrementally controlled, or enable the user to navigate a menu and make selections. One skilled in the art is familiar with buttons used to provide user interface to a digital camera.

The interface subsystem 224 further comprises an image display. The image display enables the user to view a digital image stored in the memory subsystem 223. In addition, the image display can provide a ‘real-time’ view of the image incident on the image sensing and recording portion of the imaging subsystem 222. In addition to viewing images, the image display provides a means for displaying menus that allows the user to select various operational modes with respect to various embodiments of the present invention. Moreover, the image display provides directories that allow the user to view and manipulate the contents of the memory subsystem 223. The image display is typically a liquid crystal (LCD) display or similar display useful for displaying digital images.

In some embodiments, the virtual keyboard 210 provides an alternate means for accessing the functionality supported by the buttons to interact with the control program 226. In other words, the virtual keyboard 210 may implement some or all of the functionality provided by the buttons of the interface subsystem 224. In some embodiments, the virtual keyboard 210 provides a means for introducing additional functionality by way of data entry that extends or exceeds the capability of that provided by buttons of the interface subsystem 224. For example, the virtual keyboard 210 may provide a QWERTY keyboard form of input not present in the physical buttons of the interface subsystem 224.

The power subsystem 225 comprises a power supply, a monitor, and a battery. The power supply has an input connected to the AC adaptor port and an output that provides power to the rest of the exemplary digital camera 200. In addition, the power supply has a connection to the battery. The power supply can draw power from or supply power to the battery using this connection.

The control program 226 comprises a control portion that comprises instructions that, when executed by the controller 221, implement the various control functions described above. The control program 226 further comprises a virtual keyboard portion that comprises instructions that, when executed by the controller 221, implement converting the location of the sound detected by the transducers 212 of the virtual keyboard 210 into a specific data type, for example, data representing corresponding keys of the virtual keyboard 210. In some embodiments, the instructions further implement determining a location of a sound created by tapping on or dragging a finger across the sounding surface 202. For example, determining may employ data from the array of acoustic transducers 212 to triangulate a point of origin of the created sound using a differential time-to-arrival algorithm. In some embodiments, the instructions use the location determined by the signal processor 214. The instructions further implement mapping the determined location of the sound into a data entry. For example, mapping may compare the determined location to a predefined map of data associated with specific locations on the sounding surface 202. Based on the comparison, a particular entry is selected from the associated data (e.g., the pre-defined map may correspond to keys of a QWERTY keyboard represented as a series of boxes distributed on the sounding surface). The selected entry or ‘key’ is the data entry generated by the execution of the instructions.

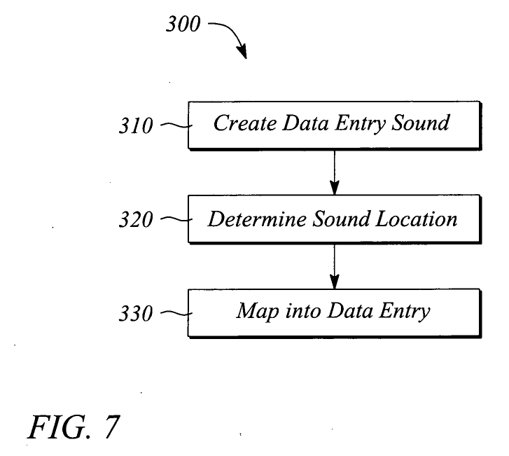

FIG. 7 illustrates a flow chart of a method 300 of data entry for a portable electronic device using an acoustic virtual keyboard according to an embodiment of the present invention. The method 300 of data entry comprises creating 310 a sound or vibration representing an input or data entry to the electronic device. Herein, the term ‘sound’ will be used to mean one or both of a noise or a vibration unless otherwise indicated. In some embodiments, the sound is created 310 using a sounding surface such as, but not limited to, a table, desk, or counter. In some embodiments of using a sounding surface, the portable electronic device is in contact with or supported by the sounding surface. For example, creating 310 the sound may comprise tapping on the sounding surface. In another example, creating 310 may comprise dragging a finger across the sounding surface. The sounding surface vibrates and/or emits a noise when tapped or otherwise touched. The sound emanates from a point of origin of the tap or touch location, such as a wave, for example, and is detected by means for sensing sound of the electronic device. In some embodiments, the sound travels within, through or along the sounding surface from the point of origin to the portable electronic device. In other embodiments, the sound is transmitted through air adjacent to the sounding surface.

The method 300 of data entry further comprises determining 320 a location or the point of origin of the created 310 sound. In some embodiments, the point of origin is determined 320 using the means for sensing sound, such as an array of transducers of the virtual keyboard. In particular, the array of transducers is employed to triangulate the point of origin of the created 310 sound. For example, a differential time-to-arrival algorithm may be employed to triangulate and determine 320 the location based on known locations of the transducers in the array.

The method 300 of data entry further comprises mapping 330 the determined 320 point of origin into a data entry. In particular, mapping 330 comprises comparing the determined 320 point or origin to a predefined map of data associated with specific locations. Based on the comparison, a particular entry is selected from the associated data. For example, the pre-defined map may correspond to keys of a QWERTY keyboard represented as a series of boxes, as if distributed on the sounding surface. In this example, the data are the key values associated with the keys in the QWERTY keyboard. Mapping 330 compares the determined 320 point of origin of the sound with the series of boxes hypothetically distributed on the sounding surface and selects a key corresponding to the determined 320 location. The selected key is the data entry generated by the method 300.

In some embodiment, the method 300 further comprises employing a template to assist in creating 310 the sound at a point of origin corresponding to a specific location within the predefined data entry map. In such embodiments, the method 300 optionally further comprises registering the template. Additional details regarding the template, its use and registering thereof, are described hereinabove with respect to the virtual keyboard apparatus 100.

In some embodiments, the control program 226 of the electronic device 200 implements portions of the method 300. In particular, in some embodiments, the virtual keyboard portion of the control program 226 implements determining 320 the sound location and mapping 330 the sound location into a data entry.

In some embodiments, the transducer array 110, 212 may be used for other purposes in addition to that described hereinabove with respect to the virtual keyboard 100, 210. For example, the transducer array 212 may be employed as a means for directive or selective sound reception for the electronic device 200. Directive or selective sound reception includes, but is not limited to, those that provide noise cancellation and spatial filtering. As such, the transducer array 212 of the virtual keyboard 210 may provide the electronic device 200 with means for inputting as well as means for noise-canceling sound recording, for example. In another example, the electronic device 200 such as, but not limited to, a digital camera 200, may be afforded both a virtual input means and means of spatially filtering and recording sounds associated with an image being recorded by virtue of the incorporated transducer array 212.

Thus, there have been described embodiments of a virtual keyboard apparatus and a method of using a virtual keyboard with an electronic device. Further, embodiments of an electronic device with a virtual keyboard have been described. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A virtual input apparatus comprising:
an array of vibration transducers; and
a signal processor connected to an output of the transducer array, an output of the signal processor providing data corresponding to a determined location of a vibration detected by the transducer array,
wherein the transducer array is in contact with a sounding surface, the sounding surface transmitting the vibration detected by the transducer array.

2. The virtual input apparatus of claim 1, further comprising:
a template that provides a guide to locations on the sounding surface relative to the transducer array, the locations representing virtual data,
wherein the location of the vibration corresponds to a location of the virtual data of the template, the virtual data corresponding to the data from the signal processor output.

3. The virtual input apparatus of claim 2, wherein the template is a keyboard template, keys of the keyboard template representing the virtual data, wherein the keyboard template is a sheet of material marked with key locations that mimic a keyboard.

4. The virtual input apparatus of claim 3, wherein the keyboard template is manipulatable for compact storage when not in use.

5. The virtual input apparatus of claim 2, wherein the template is a keyboard template that is an optical projection on the sounding surface, the projection providing key locations that mimic a keyboard.

6. The virtual input apparatus of claim 5, wherein the keyboard template is projected from an electronic device that comprises the virtual input apparatus, the projection being positioned on the sounding surface in relation to a location of the electronic device on the sounding surface.

7. The virtual input apparatus of claim 2, wherein the template is registered with respect to the transducer array using one or both of interactive registration and automatic registration.

8. The virtual input apparatus of claim 1, wherein the array of transducers comprises two or more transducers spaced apart from one another, the spaced apart transducers being arranged to form a planar geometric array pattern.

9. The virtual input apparatus of claim 8, wherein each transducer is located at a different vertex of the planar geometric array pattern.

10. The virtual input apparatus of claim 8, wherein the transducer array is incorporated into an electronic device that comprises the virtual input apparatus, the transducer array being adjacent to an external surface of the electronic device for direct contact to the sounding surface.

11. The virtual input apparatus of claim 1, wherein the signal processor determines the location of the vibration detected by the transducer array using a triangulation methodology.

12. The virtual input apparatus of claim 1, wherein the signal processor comprises a mapping function, the mapping function mapping the determined location into a stored key configuration, the key configuration being predetermined keys of a keyboard, the determined location of the vibration corresponding to a key and of the keyboard.

13. The virtual input apparatus of claim 1, wherein the signal processor is a processor of an electronic device that is equipped with the virtual input apparatus, the processor acting as the signal processor of the virtual input apparatus while receiving an input from the transducer array.

14. An electronic device comprising:
device electronics that provide functionality and control of the electronic device; and
a virtual keyboard that comprises an array of vibration transducers,
wherein the transducer array in contact with a sounding surface detects a location of a sound produced by a user of the electronic device whom is entering data, the transducer array providing a signal to the device electronics that is processed into data understood by the electronic device corresponding to data being entered by the user.

15. The electronic device of claim 14, wherein the device electronics comprise a controller; an operational subsystem; a memory subsystem; and a control program that is stored in the memory subsystem, one or both of the virtual keyboard and the device electronics further comprising a signal processor,
wherein the controller executes the control program and controls the operational subsystem, the power subsystem and the memory subsystem.

16. The electronic device of claim 15, wherein the control program comprises a control portion and a virtual keyboard portion, the virtual keyboard portion comprising instructions that, when executed by the controller, implement converting the signal from the transducer array into a specific data input type, the instructions further implementing mapping the specific data input type into input data used by the electronic device.

17. The electronic device of claim 14, wherein the electronic device is one or both of a portable personal electronic device (PED) and a docking station for the PED, the PED being selected from one or more of a digital camera, a personal digital assistant (PDA), a remote control for an audio/visual system, a cellular telephone, a video game console, a portable video game unit, an MP3 player, a CD player, and DVD player.

18. A method of entering data for a portable electronic device using a virtual keyboard comprising:
creating a sound with a sounding surface, the sound representing data to be entered into the electronic device;
determining a point of origin of the created sound, the sound being transmitted from the point of origin to the virtual keyboard by the sounding surface; and
mapping the determined point of origin of the sound into the data.

19. The method of data entry of claim 18, wherein determining a point of origin comprises using an array of acoustic transducers in contact with the sounding surface; and triangulating the point of origin of the created sound.

20. The method of data entry of claim 18, wherein mapping the determined point of origin comprises comparing the determined point of origin to a predefined map of data corresponding to specific point of origin locations, and selecting a particular data entry from a corresponding specific location.

21. The method of data entry of claim 18, further comprising employing a keyboard template to assist with creating the sound, the keyboard template providing predefined points of origin corresponding to a predetermined map used during mapping to convert the determined point of origin of the created sound into the data.

22. A virtual input apparatus for an electronic device comprising:
means for detecting a sound; and
means for processing signals from the means for detecting, wherein a signal represents a detected sound, an output of the means for processing signals providing data corresponding to a location of the sound detected by the means for detecting,
wherein the means for detecting is adjacent to a sounding surface, the sounding surface transmitting the sound detected by the means for detecting.

23. The virtual input apparatus of claim 22, wherein the means for detecting a sound comprises an array of sound transducers.

24. The virtual input apparatus of claim 22, wherein the means for processing signals is a signal processor of the electronic device.

25. The virtual input apparatus of claim 22, further comprising a means for defining a location on the sounding surface for data entry, the means for defining facilitating the data entry for a user of the electronic device.

26. The virtual input apparatus of claim 25, wherein the means for defining comprises a template that corresponds to the data understood by the electronic device.

27. The virtual input apparatus of claim 26, wherein the template is registered with respect to the means for detecting by one or both of interactive registration and automatic registration.

28. The virtual input apparatus of claim 22, wherein the location of the sound from the sounding surface represents a predefined key on a virtual keyboard, the means for processing signals converting the location of the detected sound into the data that corresponds to the predefined key of the virtual keyboard.

29. A virtual input apparatus for an electronic device comprising:
an electronic device; and
means for entering virtual data into the electronic device, the means for entering being in contact with a sounding surface,
wherein the virtual data is a determined location of a vibration on the sounding surface relative to the means for entering, the virtual data corresponding to actual data used by the electronic device.

30. The virtual input apparatus of claim 29, wherein the means for entering virtual data comprises:
means for detecting the vibration; and
means for converting the determined location into actual data, one or both of the detecting means and the converting means comprises means for determining the location of the vibration.

31. The virtual input apparatus of claim 29, wherein the determined location of the vibration corresponds to an actual key location on a virtual keyboard.

32. The virtual input apparatus of claim 29, wherein the means for entering comprises a transducer array in contact with the sounding surface,
wherein the transducer array provides a signal representing the determined location of the vibration to a processor of the electronic device, the processor converting the signal into the actual data,
and wherein the means for entering optionally further comprising a template in contact with the sounding surface that is positioned relative to the transducer array, the template defining locations on the sounding surface for a user of the electronic device, the locations correspond to the actual data understood by a user of the electronic device.

33. The virtual input apparatus of claim 32, wherein the optional template is a keyboard having defined locations of keys representing actual data, the processor comprising a stored keyboard map corresponding to the keyboard template, the processor using the stored map to convert the signal from the transducer array.

34. A virtual keyboard apparatus comprising:
an array of vibration transducers in contact with a sounding surface, the transducer array detecting a vibration transmitted by the sounding surface; and
a signal processor connected to an output of the transducer array, the signal processor comprising a stored keyboard map, an output of the signal processor providing data that represents a key of the keyboard map, the key corresponding to a determined location of the detected vibration.

35. The virtual keyboard apparatus of claim 34, further comprising:
a keyboard template that provides a guide to locations on the sounding surface relative to the transducer array, the keyboard template corresponding to the stored keyboard map, such that a location of the vibration corresponds to a location of a key of the keyboard template that corresponds to the key of the stored keyboard map.
